(19) United States
(12) Patent Application Publication
(10) Pub. No.: US 2016/0133220 A1
(43) Pub. Date: May 12, 2016

(54) PROGRAMMABLE DISPLAY DEVICE

(71) Applicant: MITSUBISHI ELECTRIC CORPORATION, Chiyoda-ku, Tokyo (JP)

(72) Inventor: Yohei ITAYA, Tokyo (JP)

(73) Assignee: Mitsubishi Electric Corporation, Tokyo (JP)

(21) Appl. No.: 14/769,869

(22) PCT Filed: Apr. 26, 2013
(86) PCT No.: PCT/JP2013/062428

§ 371 Date: Aug. 24, 2015

(51) Int. Cl. G09G 5/00; G06F 3/14; G09G 5/399

(52) U.S. Cl. CPC G09G 5/001; G09G 5/399; G06F 3/1431

(57) ABSTRACT

To include a display, a touch panel, a volatile memory, a nonvolatile memory that stores therein control screen data including plural pieces of screen data, an activation control unit that develops the control screen data on the volatile memory at the time of activation, and a display control unit that displays any one of the screens, screen data of which is included in the control screen data developed onto the volatile memory, on the display and that changes a screen to be displayed according to an input operation to the touch panel. The activation control unit develops the control screen data in an order based on priority levels which are set such that an initial display screen to be first displayed at the time of activation has a highest priority level, and the display control unit displays the initial display screen on the display when the screen data of the initial display screen is developed onto the volatile memory.

### FIELD

The present invention relates to an activation process of control screen data for displaying a state of a controller in a programmable display device connected to the controller.

### BACKGROUND

A programmable display device is connected with a controller such as a PLC (programmable logic controller) and displays a state of the controller connected thereto to prompt a user to operate or monitor the controller. To display the state of the controller on the programmable display device, the user creates control screen data adapted to a target device to be controlled with an image creation device such as drawing software, and stores the control screen data in a nonvolatile memory of the programmable display device. The programmable display device operates using the control screen data stored in the nonvolatile memory.

To operate at a high speed during an operation, the programmable display device has a mechanism in which the control screen data stored in the nonvolatile memory is developed onto the volatile memory, which performs high-speed I/O (Input/Output) processing, at the time of activation of the programmable display device, and during the operation, the programmable display device operates using the control screen data developed on the volatile memory.

The user can create an arbitrary pieces of screen data to be adapted to the target device to be controlled. Accordingly, when there is a plurality pieces of the screen data, development processing from the nonvolatile memory onto the volatile memory is performed for each piece of screen data. After development of all the pieces of screen data is completed, a piece of screen data to be displayed first after the activation, which is set in advance by a screen-data creation device such as drawing software, is displayed on a display unit. The activation of the programmable display device is thus completed.

Patent Literature 1 discloses a method of creating information that specifies an initial display screen after activation of a programmable display device, for example, by drawing software.

Patent Literature 2 discloses a method of providing information of a preferential display screen which is used for storing only screen data with a high display frequency in a volatile memory to increase the display speed of a programmable display device.

### CITATION LIST

### Patent Literatures

Patent Literature 1: Japanese Patent Application Laid-open No. 2007-079670

Patent Literature 2: Japanese Patent Application Laid-open No. 2000-020112

### SUMMARY

### Technical Problem

The user can create an arbitrary pieces of control screen data. When the number of pieces of screen data is large and their data sizes are large, it takes time to develop the control screen data from the nonvolatile memory onto the volatile memory at the time of activation of the programmable display device. At that time, the plurality pieces of the control screen data stored in the nonvolatile memory are developed in the ascending order of screen numbers starting from the first screen data.

A conventional programmable display device cannot display an initial display screen after activation on the screen of the programmable display device until development of all the pieces of control screen data stored in the nonvolatile memory onto the volatile memory is completed. Accordingly, when the number of pieces of screen data is large and their data sizes are large, it takes a long time to display the initial display screen after the activation on the screen of the programmable display device. This may cause user's dissatisfaction.

The present invention has been achieved in view of the above problems, and an object of the present invention is to provide a programmable display device that can shorten a waiting time, which is felt by a user, before completion of the activation of the programmable display device.

### Solution to Problem

To solve the above problems and achieve the object a programmable display device of the present invention includes: a display unit; an operation unit; a volatile memory; a nonvolatile memory that stores therein control screen data including data of a plurality of screens; an activation control unit that develops the control screen data on the volatile memory at a time of activation; and a display control unit that displays, on the display unit, any one of the screens that includes data in the control screen data developed onto the volatile memory, and that changes a screen displayed on the display unit according to an input operation to the operation unit The activation control unit develops the control screen data in an order based on priority levels which are set for the data of the screens such that an initial display screen to be first displayed at the time of activation has a highest priority level, and the display control unit displays the initial display screen on the display unit when data of the initial display screen is developed onto the volatile memory.

### Advantageous Effects of Invention

The programmable display device according to the present invention can shorten the time taken to display the initial display screen after activation on a screen of the programmable display device.

### BRIEF DESCRIPTION OF DRAWINGS

FIG. 1 is a diagram illustrating a configuration of a programmable display device according an embodiment of the present invention.

FIG. 2 is a diagram illustrating details of priority information.

FIG. 3 is a diagram illustrating an example of a relation among pieces of screen data included in control screen data.

FIG. 4 is a flowchart illustrating a process of creating priority information.

FIG. 5 is a flowchart illustrating a process of updating initial display flags in priority information at the time of activation of the programmable display device.

FIG. 6 is a flowchart illustrating a process of updating priority information during an operation of the programmable display device.

FIG. 7 is a flowchart illustrating a process of developing control screen data at the time of activation of the programmable display device.

### DESCRIPTION OF EMBODIMENTS

Exemplary embodiments of a programmable display device according to the present invention will be explained below in detail with reference to the accompanying drawings. The present invention is not limited to the embodiments.

### Embodiment

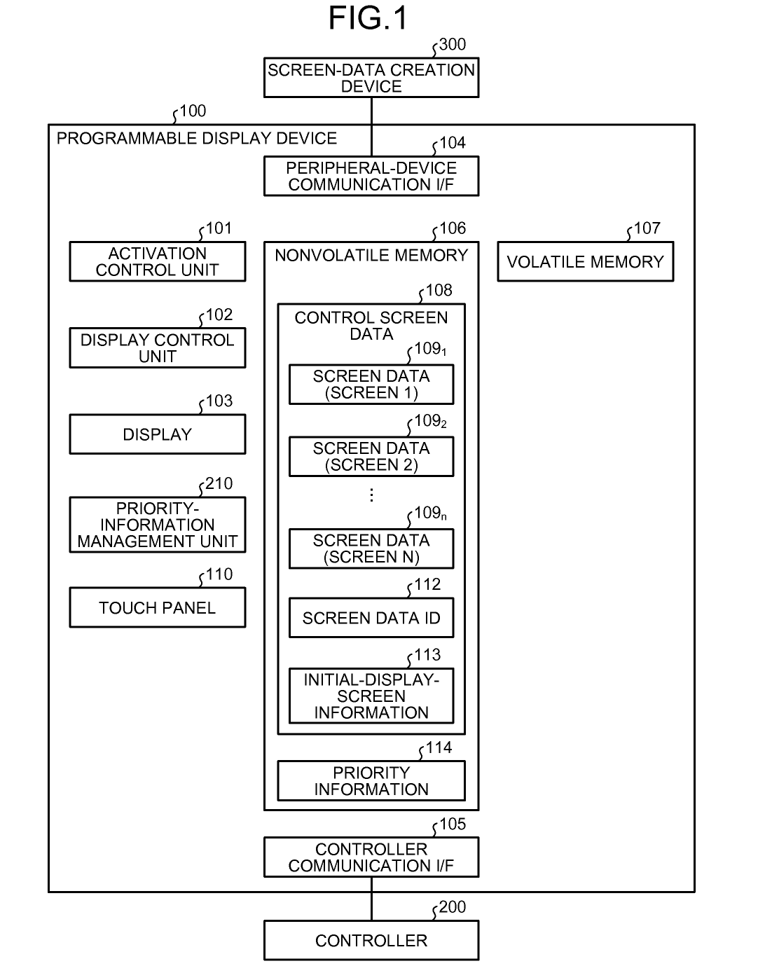

FIG. 1 is a diagram illustrating a configuration of a programmable display device according an embodiment of the present invention. A programmable display device 100 includes an activation control unit 101, a display control unit 102, a display 103 (display unit), a peripheral-device communication I/F (Interface) 104, a controller communication I/F 105, a nonvolatile memory 106, a volatile memory 107, and a touch panel 110 (operation unit). The programmable display device 100 further includes a priority-information management unit 210.

The programmable display device 100 is connected to a controller 200 such as a PLC via the controller communication I/F 105 to display a state of the controller 200. Control screen data 108 that displays the state of the controller 200 is created by a screen-data creation device 300 connected to the programmable display device 100.

The nonvolatile memory 106 stores therein the control screen data 108 created by the screen-data creation device 300 and priority information 114 used in processing of developing the control screen data 108 at the time of activation of the programmable display device 100.

The control screen data 108 includes N pieces of screen data 109₁ to 109ₙ for screens 1 to N, respectively. The control screen data 108 has a screen data ID 112 as a unique number for specifying the control screen data 108. The control screen data 108 has initial-display-screen information 113 indicating a screen to be first displayed after activating the programmable display device 100. The screen data ID 112 and the initial-display-screen information 113 are provided by the screen-data creation device 300 when creating the control screen data 108, and are stored in the nonvolatile memory 106 of the programmable display device 100.

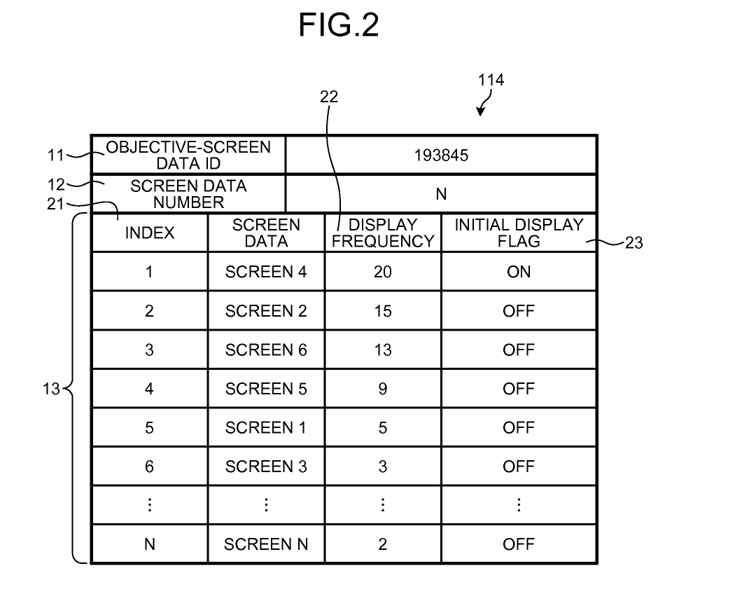

FIG. 2 is a diagram illustrating details of the priority information. The priority information 114 is constructed of an objective-screen data ID 11 for specifying the control screen data 108 to be activated, a screen data number 12 representing the number of pieces of screen data to be managed in the priority information 114, and a table 13 including as many rows as the pieces of screen data of the control screen data 108 stored in the nonvolatile memory 106. In the table 13, each screen has information of an index 21, a display frequency 22, and an initial display flag 23. The display frequency 22 represents the number of times a user has displayed the screen data 109₁ to 109ₙ during the operation of the programmable display device 100. The priority-information management unit 210 counts the number of times of display for each screen and records the counted values sequentially. Accordingly, the screen data 109₁ to 109ₙ having a larger value of the display frequency 22 is determined to have a higher use frequency of the user and a higher priority. The initial display flag 23 is ON only for the screen data of the initial display screen after activation set by the screen-data creation device 300. Accordingly, the initial display flag 23 is set to ON for only one of the plurality pieces of screen data 109₁ to 109ₙ existing in the control screen data 108. To accelerate table retrieval processing in the priority information 114 performed by the programmable display device 100, a piece of screen data with the initial display flag 23 set to ON is placed in a leading row and the remaining pieces of screen data are stored in the descending order of values of the display frequency 22.

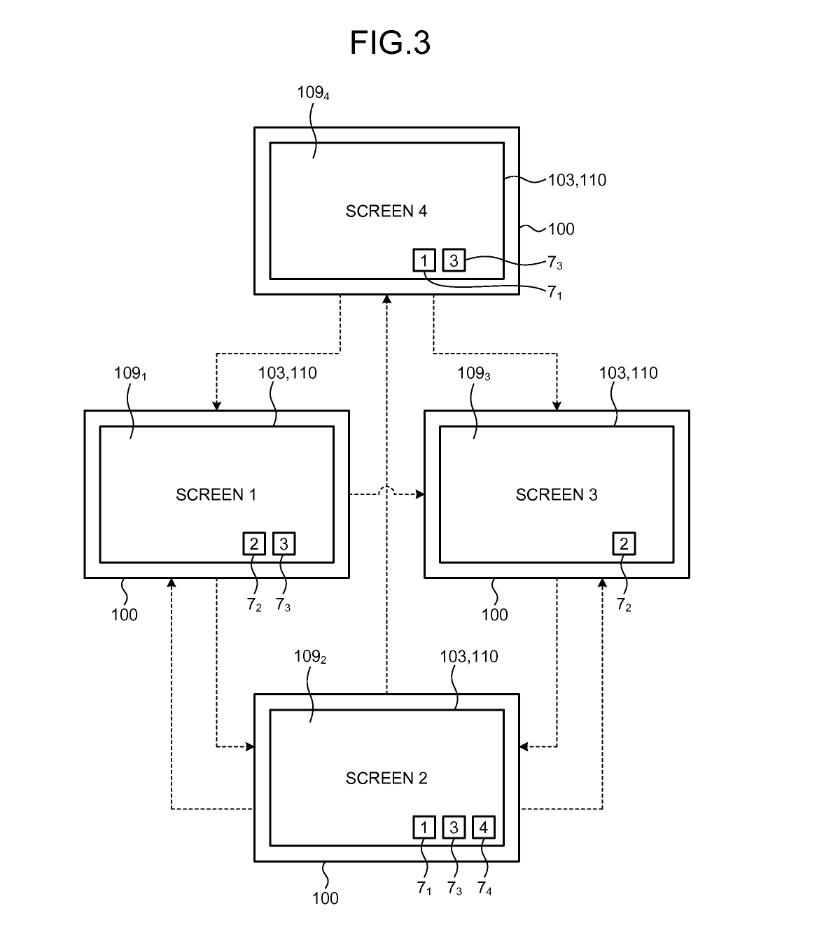

FIG. 3 is a diagram illustrating an example of a relation among the pieces of screen data included in the control screen data. In the example illustrated in FIG. 3, the number of screens is four (N=4). The display control unit 102 selectively displays one of the screens (screens 1 to 4) corresponding to the screen data 109₁ to 109₄ on the display 103. In each of the screens, screen selector switches 7₁ to 7₄ are provided. The screen selector switches 7₁ to 7₄ are switches for an operation of selecting to the screens 1 to 4, respectively. When the user touches an area where the screen selector switches 7₁ to 7₄ are displayed on the display 103, the touch panel 110 detects pressing of the switch and the display control unit 102 displays a screen corresponding to one piece of the screen data 109₁ to 109₄ on the display 103 based on the detection result by the touch panel 110. In FIG. 3, transition relations of the screens are indicated by arrows. For example, the arrow from the screen 4 to the screen 1 indicates that pressing of the screen selector switch 7₁ on the screen 4 enables transition of the screen displayed on the display 103 from the screen 4 to the screen 1.

Switches for selecting a screen to be displayed on the display 103 are not limited to those with fixed transition destinations as the screen selector switches 7₁ to 7₄ and can be those with dynamically-varying transition destinations. For example, a switch for returning to a previous screen (transitioning to the screen of a transition source) can be provided. The transition destination at the time of pressing such a switch dynamically varies depending on the screen of a transition source.

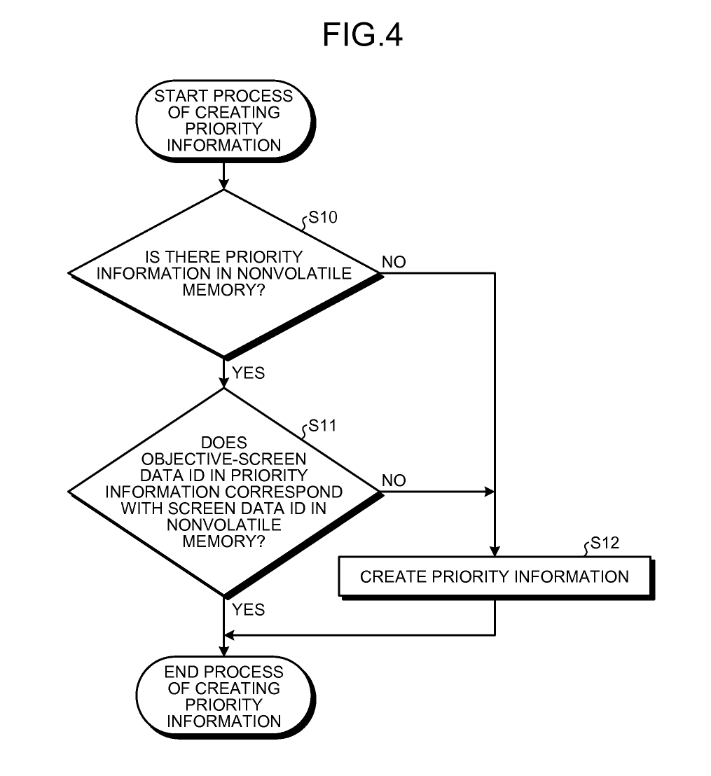

FIG. 4 is a flowchart illustrating a process of creating the priority information. The priority-information management unit 210 confirms whether there is the priority information 114 in the nonvolatile memory 106 at the time of activation of the programmable display device 100 (Step S10). When there is no priority information 114 in the nonvolatile memory 106 because the programmable display device 100 is first activated (NO at Step S10), the priority-information management unit 210 creates priority information 114 in the nonvolatile memory 106 based on information (the screen data 109₁ to 109ₙ, the screen data ID 112, and the initial-display-screen information 113) acquired from the screen-data creation device 300 (Step S12).

More specifically, the priority-information management unit 210 designates an ID shown in the screen data ID 112 as the objective-screen data ID 11. The priority-information management unit 210 counts the number of the pieces of screen data 109₁ to 109ₙ to determine the screen data number 12. The priority-information management unit 210 creates the table 13 in which an index 1 is assigned to the screen data specified by the initial-display-screen information 113 and the initial display flag 23 thereof is set to ON while indexes 2 to N are assigned to the remaining screens, respectively, and the initial display flags 23 thereof are set to OFF. None of the screen data 109₁ to 109ₙ has been displayed when the priority information 114 is created and thus the display frequencies 22 of all the indexes are zero.

When there is the priority information 114 in the nonvolatile memory 106 (YES at Step S10), the priority-information management unit 210 checks whether the objective-screen data ID 11 in the priority information 114 corresponds with the screen data ID 112 of the control screen data 108 stored in the nonvolatile memory 106 (Step S11). When the objective-screen data ID 11 in the priority information 114 corresponds with the screen data ID 112 of the control screen data 108 stored in the nonvolatile memory 106 (YES at Step S11), it is unnecessary to create the priority information 114. The process of creating the priority information 114 is thus ended.

When the user changes the control screen data 108 to different control screen data due to, for example, change of the controller 200 as a control target and thus the objective-screen data ID 11 in the priority information 114 does not correspond with the screen data ID 112 of the control screen data 108 stored in the nonvolatile memory 106 (NO at Step S11), the priority-information management unit 210 creates new priority information 114 based on the pieces of screen data 109₁ to 109ₙ, the screen data ID 112, and the initial-display-screen information 113 of the control screen data 108 stored in the nonvolatile memory 106 (Step S12).

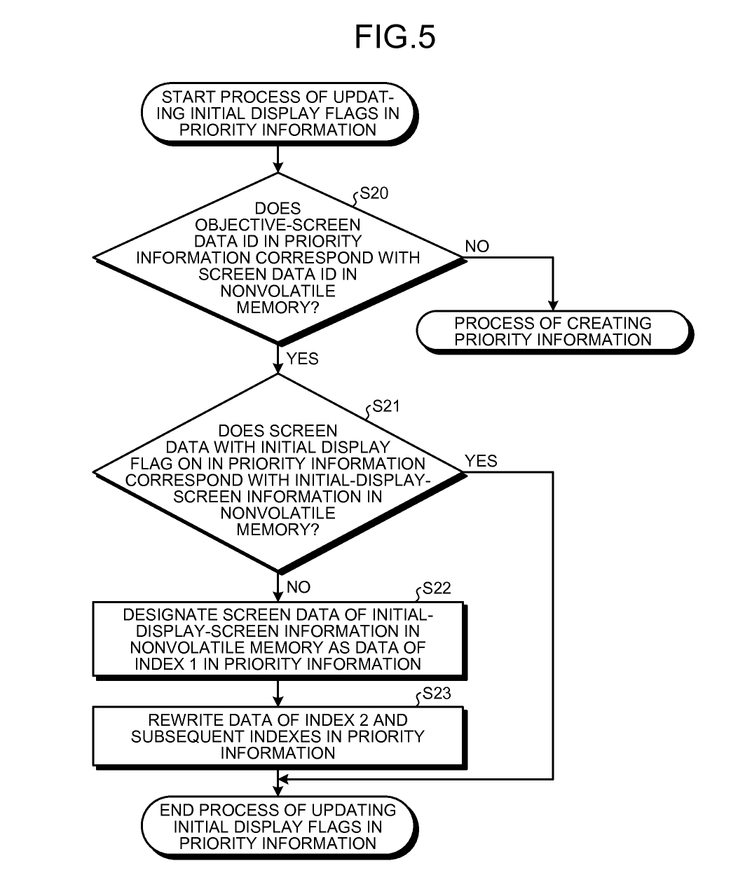

FIG. 5 is a flowchart illustrating a process of updating the initial display flags in the priority information at the time of activation of the programmable display device. The priority-information management unit 210 confirms whether the objective-screen data ID 11 in the priority information 114 corresponds with the screen data ID 112 of the control screen data 108 stored in the nonvolatile memory 106 (Step S20).

When the objective-screen data ID 11 in the priority information 114 does not correspond with the screen data ID 112 of the control screen data 108 stored in the nonvolatile memory 106 (NO at Step S20), the priority-information management unit 210 performs the process of creating the priority information 114 illustrated in FIG. 4.

When the objective-screen data ID 11 in the priority information 114 corresponds with the screen data ID 112 of the control screen data 108 stored in the nonvolatile memory 106 (YES at Step S20), the priority-information management unit 210 confirms whether the screen data with the initial display flag 23 set to ON in the priority information 114 corresponds with the initial-display-screen information 113 of the control screen data 108 stored in the nonvolatile memory 106 (Step S21).

When the screen data with the initial display flag 23 set to ON in the priority information 114 corresponds with the initial-display-screen information 113 of the control screen data 108 stored in the nonvolatile memory 106 (YES at Step S21), the process of updating the initial display flags 23 is ended.

When the screen data with the initial display flag 23 set to ON in the priority information 114 does not correspond with the initial-display-screen information 113 of the control screen data 108 stored in the nonvolatile memory 106 (NO at Step S21), the priority-information management unit 210 designates the screen data indicated by the initial-display-screen information 113 of the control screen data 108 stored in the nonvolatile memory 106 as screen data in the row of the index 1 in the priority information 114 (Step S22). Next, the priority-information management unit 210 rewrites the screen data in the row of the index 2 and the subsequent rows in the priority information 114 (Step S23). The process of updating the initial display flags 23 in the priority information 114 is thus ended.

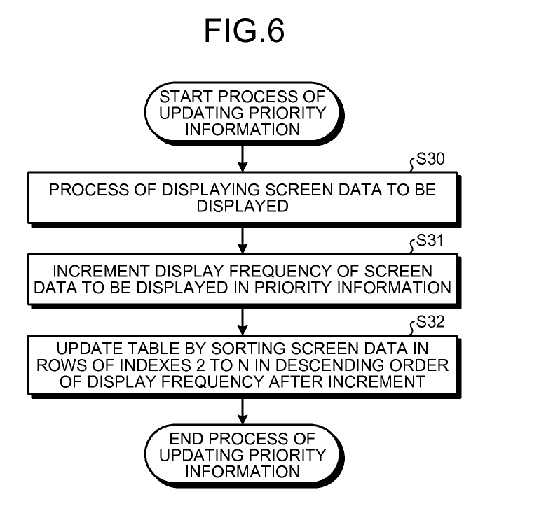

FIG. 6 is a flowchart illustrating a process of updating the priority information during the operation of the programmable display device. The display control unit 102 displays screen data to be displayed on the display 103 at the time of activation of the programmable display device 100 or based on a screen switching instruction by the user (an operation of pressing the screen selector switch) (Step S30). The priority-information management unit 210 increments the display frequency 22 of the screen data to be displayed in the priority information 114 (Step S31). The priority-information management unit 210 updates the table 13 by sorting the screen data in the rows of the indexes 2 to N in the descending order based on the values of the display frequency 22 after the increment (Step S32).

As described later, in developing the control screen data 108 in the nonvolatile memory 106 onto the volatile memory 107, the screen data 109₁ to 109ₙ are developed in the index order. Therefore, through the process of updating the initial display flags and the process of updating the priority information, the priority levels are set for the screen data 109₁ to 109ₙ, respectively, in such a manner that the screen data of the initial display screen has the highest priority.

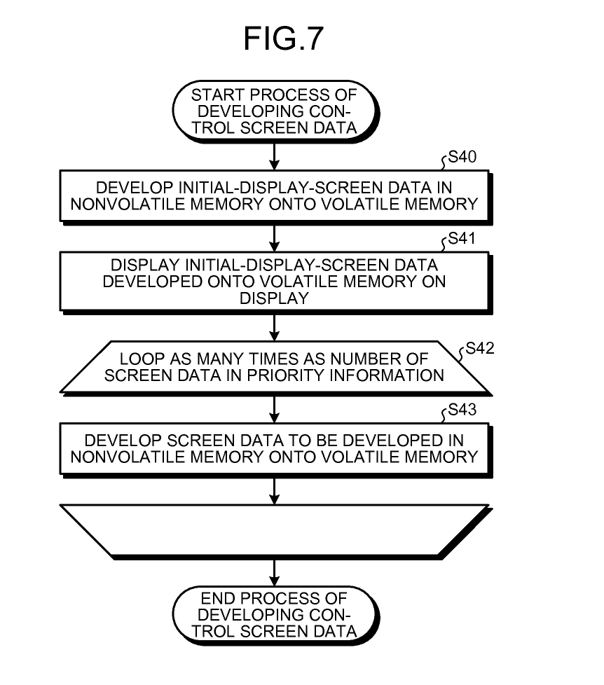

FIG. 7 is a flowchart illustrating a process of developing the control screen data at the time of activation of the programmable display device. At the time of activation of the programmable display device 100, the activation control unit 101 develops the screen data of the initial display screen of the control screen data 108 stored in the nonvolatile memory 106 (the screen data in the row of the index 1) onto the volatile memory 107 based on the priority information 114 (Step S40). After the screen data of the initial display screen is developed onto the volatile memory 107, the display control unit 102 displays the initial display screen on the display 103 (Step S41). Next, the above processes are looped as many times as the number of the pieces of screen data in the priority information 114 (Step S42). Subsequently, the screen data of screens to be developed (the screen data in the rows of the indexes 2 to N) stored in the nonvolatile memory 106 are developed onto the volatile memory 107 (Step S43).

According to the present embodiment, the programmable display device 100 for constructing a system develops the screen data of the initial display screen in the control screen data 108 stored in the nonvolatile memory 106 onto the volatile memory 107 with the highest priority and displays the initial display screen on the display 103. Therefore, a waiting time, which is felt by the user, before completion of the activation can be shortened.

Further, the screen data used by the user with a higher frequency is developed onto the volatile memory 107 with a higher priority. Therefore, even when development of all the pieces of screen data of the control screen data 108 stored in the nonvolatile memory 106 is not completed, the screen data used by the user with a higher frequency can be displayed promptly on the screen of the programmable display device 100 because such screen data is highly likely to be already developed onto the volatile memory 107.

### INDUSTRIAL APPLICABILITY

As described above, the programmable display device according to the present invention is suitable for shortening a waiting time, which is felt by the user, before completion of the activation of the programmable display device, particularly in the case where the number of pieces of control screen data of the controller is large.

### REFERENCE SIGNS LIST

7₁ to 7₄ screen selector switch, 11 objective-screen data ID, 12 screen data number, 13 table, 21 index, 22 display frequency, 23 initial display flag, 100 programmable display device, 101 activation control unit, 102 display control unit, 103 display, 104 peripheral-device communication I/F, 105 controller communication I/F, 106 nonvolatile memory, 107 volatile memory, 108 control screen data, 109₁ to 109ₙ screen data, 110 touch panel, 112 screen data ID, 113 initial-display-screen information, 114 priority information, 200 controller, 300 screen-data creation device.

1. A programmable display device comprising:
a display unit;
an operation unit;
a volatile memory;
a nonvolatile memory that stores therein control screen data including data of a plurality of screens;
an activation control unit that develops the control screen data on the volatile memory at a time of activation; and
a display control unit that displays on the display unit any one of the screens, data of which is included in the control screen data developed onto the volatile memory, and that changes a screen displayed on the display unit according to an input operation to the operation unit, wherein
the activation control unit develops the control screen data in an order based on priority levels which are set for the data of the screens such that an initial display screen to be first displayed at the time of activation has a highest priority level, and
the display control unit displays the initial display screen on the display unit when data of the initial display screen is developed onto the volatile memory.

2. The programmable display device according to claim 1, wherein
the display control unit displays a screen, data of which has been developed onto the nonvolatile memory, on the display unit at a timing of an operation through the operation unit.

3. The programmable display device according to claim 1, further comprising a priority-information management unit that stores priority information indicating the priority levels in the nonvolatile memory, wherein
the activation control unit develops the control screen data in the nonvolatile memory onto the volatile memory based on the priority information.

4. The programmable display device according to claim 3, wherein the priority-information management unit updates the priority levels based on numbers of times the screens, data of which is included in the control screen data, have been displayed on the display unit, respectively.
